(19) United States
(12) Patent Application Publication
(10) Pub. No.: US 2021/0374292 A1
(43) Pub. Date: Dec. 2, 2021

(54) METHOD FOR OPERATING AN ELECTRONIC DEVICE

(71) Applicant: Robert Bosch GmbH, Stuttgart (DE)

(72) Inventors: Jorge-Juan Ramos Molinos, Stuttgart (DE); Peter Bolz, Markgroeningen (DE)

(21) Appl. No.: 17/322,801

(22) Filed: May 17, 2021

(30) Foreign Application Priority Data
May 26, 2020 (DE) 10 2020 206 526.8

(51) Int. Cl. G06F 21/75; G06F 21/57

(52) U.S. Cl. CPC G06F 21/755; G06F 21/577; G06F 21/575

(57) ABSTRACT

A method for operating an electronic device. The method includes checking an operational software of the electronic device for an unwanted manipulation. The following steps are carried out in the event that an unwanted manipulation is detected: deactivating the operational software of the electronic device; and signaling the unwanted manipulation by way of a defined modulation of an electrical current draw of the electronic device.

### CROSS REFERENCE

The present application claims the benefit under 35 U.S.C. § 119 of German Patent Application No. DE 102020206526.8 filed on May 26, 2020, which is expressly incorporated herein by reference in its entirety.

### FIELD

The present invention relates to a method for operating an electronic device. The present invention further relates to a device, which is designed to implement the method of the present invention. The present invention further relates to a computer program product.

### BACKGROUND INFORMATION

Electronic devices are increasingly exposed to unwanted, both malicious as well as benevolent, manipulations. In the course of the increasing networking of electronic devices (especially via the Internet), these threats have reached new dimensions, however, data theft also representing a possible threat. This topic applies to any, especially mutually networked electrical and electronic devices (e.g., also to the Internet of Things), now also very much to the automotive industry. Attacks on the mentioned electronic devices with the aim of manipulation aim to modify software or the configuration of the electronic devices. In this context, configurations may be expressed in data sets as well as by the presence or absence of software.

A measure against such manipulations may be to check the integrity and authenticity of software prior to starting the software. If the integrity and authenticity are in order, the software is started, otherwise it is not started. If this method for software is applied beginning at the time when the device is switched on for the initially started software and subsequently started software, then one speaks of a “secure boot” of a device. For many cases of application, the period of time required for checking the integrity and/or authenticity of software that is to be activated may be too long. The device function would be available too late, also in the event of an unexpected restart. For this reason, there also exists the method to activate the software following the start of the device initially without a check and to perform a check of the software only afterwards, in parallel with the run time. If a manipulation of the software is detected, a new activation of the software may be prevented in the next start of the device, based on this information.

This method is called “authentic boot”, the method existing in several variants. SecureBoot as well as AuthenticBoot may be applied in graduated and mixed fashion, it being important that in mixed forms AuthenticBoot should follow upon SecureBoot and not vice versa.

Many electronic devices have a boot manager as the software that is started first after the device is powered on, which selects and activates the further software to be started as a function of certain conditions. The subsequently activated software may in turn have boot manager functionalities, or may be already functional (device functionality proper for operational software). Boot managers are often very small and simple software units, which are also to be executed quickly. For this reason, they often do not have a possibility of communicating with the world outside of the device via device interfaces. In some cases, they also do not have the capability of controlling signaling means (devices) attached to the device (display, control lamps). This is especially true if these signaling means do not even exist on the device. Boot managers start, e.g., further software, which is also used for diagnosing the device in the case of a fault. In devices that have a signaling means, a reason for deactivating the device may be displayed either as a message on a display or, e.g., by switching on or flashing a fault lamp.

### SUMMARY

An object of the present invention is to provide an improved method for operating an electronic device.

The objective may be attained, according to a first aspect of the present invention. In accordance with an example embodiment of the present invention, a method for operating an electronic device includes the steps:
checking an operational software of the electronic device for an unwanted manipulation, the following steps being carried out in the event that an unwanted manipulation is detected:
deactivating the operational software of the electronic device; and
signaling the unwanted manipulation by way of a defined modulation of an electrical current draw of the electronic device.

In this manner, a deactivation of the electronic device due to a manipulative access to the software may be signaled outwardly in a simple manner. Advantageously, no signaling via a bus is required for this purpose, which bus is not available anyway. This makes it advantageously possible to determine that what is concerned here is not a fault of the hardware of the electronic device, but rather that the latter was actively shut down. In this manner, field observation data regarding such manipulations are advantageously provided, it being determined in the process that the deactivation of the electronic device was successful as an active countermeasure. As a result, this makes it possible to perform a quick first analysis of deactivated electronic devices, which is usable in particular for devices whose bus connection would only begin to function by way of a functional operational software. This is helpful in particular in an analysis of electronic devices returning from the field.

According to a second aspect of the present invention, the object may be achieved by an electronic device that is designed to carry out the example method.

According to a third aspect of the present invention, the objective is achieved by a computer program having program code, which is designed for implementing the example method when it runs on an example electronic device or is stored on a computer-readable data carrier.

Advantageous developments of the method in accordance with the present invention are disclosed herein.

In one advantageous development of the method, the software is checked using a secure boot process and/or using an authentic boot process. Advantageously, in this manner, the example method may be implemented using conventional, proved and secure boot methods for electronic devices that are conventional.

A further advantageous development of the method in accordance with the present invention provides for the defined modulation of the electrical current draw of the electronic device to be performed by at least one of the following actions: switching a load of the electronic device on and off at a defined frequency and/or a defined duty cycle and/or a defined period; drawing at least two different amperages modulated over time; transmitting an error code by a duty cycle of the electrical current draw; performing a unidirectional power line signaling. In this manner, different possibilities are provided for implementing the modulation of the electrical current consumption.

Another advantageous development of the method in accordance with the present invention provides for the method to be carried out by a boot system of the electronic device. Advantageously, following a reset of the electronic device, a segment of the boot system is thereby able to perform the mentioned signaling.

Another advantageous development of the method of the present invention provides for a part of the boot system and/or an electrical consumer of the electronic device to be switched in a defined manner. In this manner, a simple possibility is provided for implementing the intended modulation of the electrical current consumption of the electronic device. This may be accomplished, for example, by a chip, a switchable or controllable electrical load (e.g. lens heater), bus driver, parts of a processor, etc. of the electronic device. It goes without saying that the mentioned possibilities are only exemplary and that for this purpose there may exist further possibilities in accordance with the technical possibilities of the electronic device.

A further advantageous development of the method of the present invention provides for the unidirectional power line signaling to be performed permanently or in a limited, temporally defined manner. Advantageously, this makes it possible to implement different signaling modes of the device.

One advantageous development of the electronic device in accordance with the present invention is that it takes the form of an electronic control unit. Since such control units are increasingly exposed to manipulative access attempts, this represents a useful application of the device according to the present invention.

A further advantageous development of the device of the present invention provides for the electronic control unit to take the form of a radar control unit. This makes it possible for example to operate and analyze a control unit in the automotive field using the method according to the present invention.

The present invention is described below in detail with additional features and advantages on the basis of three figures. The figures are primarily intended to illustrate the main features of the present invention.

Disclosed method features result analogously from corresponding disclosed device features and vice versa. This means in particular that features, technical advantages and embodiments concerning the method for operating an electronic device result in an analogous manner from corresponding embodiments, features and advantages concerning the electronic device and vice versa.

### BRIEF DESCRIPTION OF THE DRAWINGS

FIG. 1 shows a basic flow chart of a mode of operation of a method in accordance with an example embodiment of the present invention.

FIG. 2 shows a basic block diagram of an electronic device in accordance with an example embodiment of the present invention.

FIG. 3 shows a basic representation of a method for operating an electronic device, in accordance with an example embodiment of the present invention.

### DETAILED DESCRIPTION OF EXAMPLE EMBODIMENTS

An object of the method in accordance with the present invention is in particular to provide a simple possibility for analyzing a manipulative access to an electronic device.

If during a start of the electronic device by a boot manager using the aforementioned secure boot or authentic boot method, an operating software to be started is recognized as compromised and/or not authentic for the electronic device lacking signaling means, and the further start of the software is stopped, then the electronic device is “quasi dead”. Seen from the outside, it cannot be distinguished from an electronic device that does not start due to a hardware fault. The present invention provides a possibility of making this distinction nevertheless and making it discernible.

As a result, a signaling of the desired deactivation of the electronic device to the outside is achieved by a defined variance of the electrical current consumption of the electronic device over time. Advantageously, the mentioned signaling and device deactivation also function without signal lines or display elements.

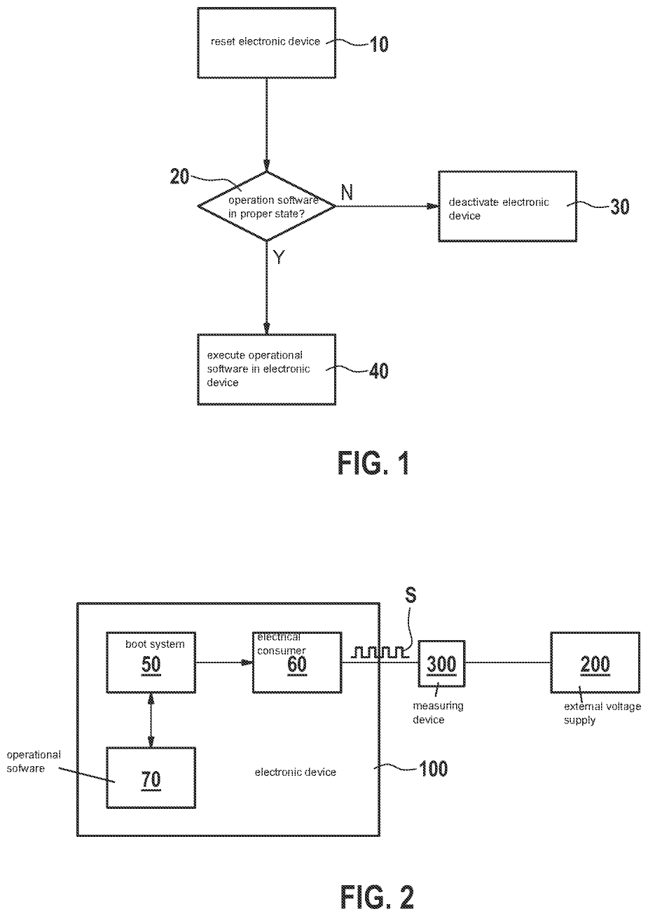

FIG. 1 shows a basic sequence of a mode of operation of the example method.

In a step 10, electronic device 100 is reset, e.g., following a return of electronic device 100 from the field.

In a step 20, a check is performed to determine whether an operational software 70 of electronic device 100 is in a proper state. This may be achieved, e.g., by way of a conventional signature method using a public key situated in electronic device 100 and an associated private key, in which the integrity and the proper state of operational software 70 are verified.

If this is the case, then the proper operational software 70 is executed in electronic device 100 in a step 40. Otherwise, that is, if the proper functionality of the operational software 70 is not verified in step 20, electronic device 100 is deactivated in a step 30 and this state is signaled via a modulated electrical current draw of electronic device 100.

As a result, there is thus a deactivation of electronic device 100 including outward signaling by a defined variance of the current consumption over time. The temporally defined variance of the current consumption may occur in various ways, which are listed below merely by way of example:
provision of at least two different device load amperages variable over time having a fixed period and a fixed on/off duty cycle,
variation of the period of the electrical current,
variation of the duty cycle (e.g. 50/50, etc.) of the electrical current,
temporally defined variation of electrical amperages (“amperage modulation”),
provision of multiple different cyclical amperages,
any combination of the mentioned methods,
provision of encoded current signals using ASCII, BCD, binary codes, etc.
provision of a permanent or time-limited unidirectional power line communication or signaling.

In time-limited power line signaling, the latter may be performed, e.g., only for a few seconds following a device start and a detection of an unwanted manipulation. For example, this may occur up to a reset by a switch-off or up to a point in time at which a device watchdog performs a reset.

It can be seen that there exists a multitude of relevant possibilities, even ones not mentioned here, for implementing the variation of the current consumption over time of electronic device 100.

Electronic devices 100 without additional display or signal lines, for which the example method may be used, are, e.g., radar sensors used inter alia in the automotive sector. A boot manager software of the radar sensors is small and contains no possibility for transmitting signals to a vehicle bus. Existing lines of the radar sensors for bus connections also must not be used for signaling, since an existing bus communication between other control units in the vehicle must not be disturbed. Furthermore, a radar sensor normally does not have any display elements.

A radar sensor is normally completely welded in and may have a plug connector typically having eight pins (e.g., two pins for the voltage supply, further pins for bus connections). The present invention provides for signaling a modulated voltage or current supply of the radar sensor via the two voltage supply pins.

Boot system 50 or the boot manager of the radar sensor also does not have the option of activating the transmission of radar signals. In some variants, however, a radar sensor has the option of activating an electrical lens heater for removing ice and snow in winter operation. In connection with the example method, the activation of the lens heater may be used in order to modulate the electrical current consumption of the radar sensor over time, which makes it possible to change the electrical current consumption of the radar sensor significantly.

Advantageously, it is thus not necessary to open a closed radar sensor, which is normally very cost intensive and not possible to accomplish in a non-destructive manner. In electronic devices 100 in the form of radar sensors, the present invention may thus be implemented very usefully for non-destructive return analysis. Additional manufacturing costs are advantageously not incurred and the example method may therefore be implemented in a simple manner in the boot manager.

FIG. 2 shows a block diagram of an example electronic device 100 in accordance with the present invention. Within electronic device 100, a boot system 50 (boot manager) may be seen, which takes the form of software and which checks or verifies an operational software 70 for providing the actual functionality of the electronic device 100 (for example, for communicating with other control units, emitting radar signals, evaluating reflected radar signals, initiating braking, steering and gas requests, initiating stop-and-go functionality, etc. to a vehicle) in the manner explained above for manipulative modification.

Functionally connected to boot system 50 is an electrical consumer 60, for example in the form of a lens heater, a chip, a processor, etc., which is switched on and off in a temporally defined manner in the event that the operational software is verified to be improperly functioning, in order to generate a modulated electrical current signal S in this manner. The electrical energy supply of electronic device 100 is implemented by an external voltage supply 200, the current consumption being detected and analyzed by a measuring device 300. This allows for a quick initial analysis of the electronic device 100 returning from the field.

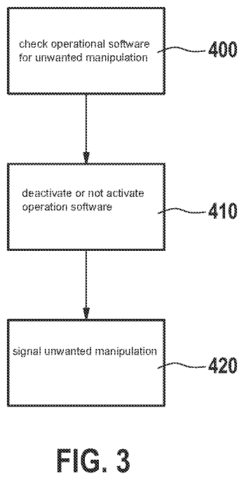

FIG. 3 shows a basic sequence of an example method in accordance with the present invention for operating an electronic device 100.

In a step 400, an operational software 70 of electronic device 100 is checked for unwanted manipulation.

In the event that an unwanted manipulation of operational software 70 is detected, the following steps are carried out:

In a step 410, the operational software (70) of electronic device 100 is deactivated or not activated.

In a step 420, the unwanted manipulation is signaled by way of a defined modulation of an electrical current draw of electronic device 100.

Advantageously, the example method may be implemented in the form of a software program having suitable program code for boot system 50, which may be implemented with little technical effort and runs on an electronic device 100. This allows for a simple adaptability of the method.

In summary, the present invention provides a method, which makes it possible to detect, and outwardly signal via a current signal, an attempted, intentionally manipulative access (e.g., hacker attack) to an electronic device that lacks a signaling element (e.g., display, LED, etc.). Advantageously, this makes it possible to determine that the faulty behavior of the electronic device was not caused by a hardware malfunction. Advantageously, it is possible in this manner to provide field observation data, which in the future will more and more frequently be the subject of respective standards.

One skilled in the art recognizes that the example electronic device 100 is disclosed as a radar sensor merely by way of example and that the present invention is advantageously applicable for numerous other electronic devices that are at risk of unwanted manipulation.

One skilled in the art will suitably modify and/or combine with one another the features of the present invention, in view of the disclosure herein, without deviating from the essence of the present invention.

1-10. (canceled)

11. A method for operating an electronic device, comprising the following steps:
checking an operational software of the electronic device for an unwanted manipulation; and
based on detecting the unwanted manipulation, carrying out the following steps:
deactivating the operational software of the electronic device, and
signaling the unwanted manipulation by way of a defined modulation of an electrical current draw of the electronic device.

12. The method as recited in claim 11, wherein the checking of the operational software is carried out using a secure boot process and/or using an authentic boot process.

13. The method as recited in claim 11, wherein the defined modulation of the electrical current draw of the electronic device is achieved by at least one of the following actions:
switching a load of the electronic device on and off at a defined frequency and/or a defined duty cycle and/or a defined period;
drawing at least two different amperages modulated over time;
transmitting an error code by a duty cycle of the electrical current draw;
performing a unidirectional power line signaling.

14. The method as recited in claim 13, wherein the unidirectional power line signaling is performed permanently or in a limited temporally defined manner.

15. The method as recited in claim 11, wherein the method is carried out by a boot system of the electronic device.

16. The method as recited in claim 13, wherein a part of the boot system and/or an electrical consumer of the electronic device are switched in a defined manner.

17. An electronic device, configured to:
check an operational software of the electronic device for an unwanted manipulation; and
based on detecting the unwanted manipulation, the electronic device is configured to:
deactivate the operational software of the electronic device, and
signal the unwanted manipulation by way of a defined modulation of an electrical current draw of the electronic device.

18. The electronic device as recited in claim 17, wherein the electronic device is an electronic control unit.

19. The electronic device as recited in claim 18, wherein the electronic control unit is a radar control unit.

20. A non-transitory computer-readable data carrier on which is stored a computer program having program code for operating an electronic device, the program code, when executed by an electronic device, causing the electronic device to perform the following steps:
checking an operational software of the electronic device for an unwanted manipulation; and
based on detecting the unwanted manipulation, carrying out the following steps:
deactivating the operational software of the electronic device, and
signaling the unwanted manipulation by way of a defined modulation of an electrical current draw of the electronic device.
